(19) United States
(12) Patent Application Publication
(10) Pub. No.: US 2025/0093465 A1
(43) Pub. Date: Mar. 20, 2025

(54) LASER DETECTION DEVICE

(71) Applicant: SUTENG INNOVATION TECHNOLOGY CO., LTD., Shenzhen (CN)

(72) Inventor: Jie LUO, Shenzhen (CN)

(73) Assignee: SUTENG INNOVATION TECHNOLOGY CO., LTD., Shenzhen (CN)

(21) Appl. No.: 18/784,947

(22) Filed: Jul. 26, 2024

(30) Foreign Application Priority Data
Sep. 18, 2023 (CN) 202311206297.2

(51) Int. Cl. G01S 7/48; G01S 7/481; G01S 7/4865; G01S 17/58

(52) U.S. Cl. CPC G01S 7/4802; G01S 7/4814; G01S 7/4865; G01S 17/58

(57) ABSTRACT

The embodiments of the present application disclose a laser detection device. The laser detection device includes a laser emitter, a laser detector, and a laser echo signal processing circuitry. The laser emitter emits a laser to the target object. The laser detector receives an echo signal reflected by the target object. The laser echo signal processing circuitry samples the echo signal. The laser echo signal processing circuitry includes a controller, a time digital converter, and a dynamic threshold value generation circuit. The controller outputs a digital signal to the dynamic threshold value generation circuit. The dynamic threshold value generation circuit generates at least two analog threshold signals to the time digital converter. The time digital converter samples the echo signal based on the threshold signals.

### CROSS-REFERENCE TO RELATED APPLICATION

The present application claims the benefit of priority to Chinese Patent Application No. 202311206297.2, filed on Sep. 18, 2023, which is hereby incorporated by reference in its entirety.

### TECHNICAL FIELD

This application pertains to the field of laser detection technology, and more particularly, to a laser detection device.

### TECHNICAL BACKGROUND

Laser detection devices are systems that use laser beams to detect features such as the position and speed of a target. The working principle is to first emit a detection laser at the target, then compare a received echo signal reflected from the target with the emitted signal, and after appropriate processing, obtain relevant information about the target, such as distance, azimuth, altitude, speed, attitude, and even shape.

Currently, due to hardware defects in laser detection devices, sampling accuracy is poor, which in turn affects the detection performance of the laser detection devices.

### SUMMARY

Embodiments of this application provide a laser detection device capable of sampling echo signals through multiple threshold signals, to improve sampling accuracy and thereby enhance the detection performance of the laser detection device.

In a first aspect, an embodiment provides a laser detection device, which includes: a laser emitter configured to emit a laser to a target object; a laser detector configured to receive an echo signal reflected by the target object; and a laser echo signal processing circuitry configured to sample the echo signal. The laser echo signal processing circuitry includes a controller, a time digital converter, and a dynamic threshold value generation circuit. The controller is electrically connected to the time digital converter through the dynamic threshold value generation circuit; the controller is configured to output a digital signal to the dynamic threshold value generation circuit; the dynamic threshold value generation circuit is configured to generate at least two analog threshold signals to the time digital converter based on the digital signal; and the time digital converter is configured to sample the echo signal based on the threshold signals.

In an embodiment, the controller includes a first digital signal input/output port. The digital signal output by the first digital signal input/output port includes a pulse width modulation signal; the dynamic threshold value generation circuit includes a filtering branch electrically connected between the first digital signal input/output port and the time digital converter. The filtering branch is configured to receive the pulse width modulation signal and filter the pulse width modulation signal to generate the threshold signal; different duty cycles of the pulse width modulation signal correspond to different threshold signals.

In an embodiment, the controller further includes a second digital signal input/output port. The digital signal output by the second digital signal input/output port includes a first high-level signal or a low-level signal; the dynamic threshold value generation circuit further includes a summing branch electrically connected to the filtering branch, the second digital signal input/output port, and the time digital converter. The summing branch is configured to sum a voltage signal obtained based on the first high-level signal or the low-level signal and the voltage signal obtained by filtering the pulse width modulation signal, to generate the threshold signals; when the duty cycle of the pulse width modulation signal remains unchanged, the threshold signals corresponding to the first high-level signal and the low-level signal are different.

In an embodiment, the dynamic threshold value generation circuit further includes a level conversion branch; the level conversion branch is connected between the second digital signal input/output port and the summing branch. The level conversion branch is configured to output a second high-level signal or the low-level signal based on the digital signal output by the second digital signal input/output port, where the voltages corresponding to the first high-level signal and the second high-level signal are different; the summing branch is further configured to sum a voltage signal obtained based on the second high-level signal or the low-level signal and the voltage signal obtained by filtering the pulse width modulation signal to generate the threshold signal; when the duty cycle of the pulse width modulation signal remains unchanged, the threshold signals corresponding to the second high-level signal and the low-level signal are different.

In an embodiment, the filtering branch includes a first resistor and a first capacitor; the first resistor and the first capacitor are connected in series between the first digital signal input/output port and the ground, and the common node between the first resistor and the first capacitor is electrically connected to the time digital converter.

In an embodiment, the summing branch includes a second resistor and a third resistor; the second resistor is electrically connected between the filtering branch and the time digital converter, and the third resistor is electrically connected between the second digital signal input/output port and the time digital converter.

In an embodiment, the level conversion branch includes a switch tube and a fourth resistor; a control end of the switch tube is electrically connected to the second digital signal input/output port. One non-control end of the switch tube is connected to the first end of the fourth resistor and the summing branch, while the other non-control end of the switch tube is grounded. The second end of the fourth resistor inputs a voltage corresponding to the second high-level signal. When the second digital signal input/output port outputs the first high-level signal, the switch tube is turned on and outputs the low-level signal; when the second digital signal input/output port outputs the low-level signal, the switch tube is turned off and outputs the second high-level signal.

In an embodiment, the time digital converter is further configured to output a pulse signal based on the sampling result. The pulse signal includes at least one pulse, and each pulse is output when the echo signal is greater than or equal to the threshold signals; the controller is further configured to adjust the digital signal based on the pulse signal, to adjust the threshold signal output by the dynamic threshold value generation circuit.

In an embodiment, the controller is further configured to adjust the digital signal to increase the threshold signal output by the dynamic threshold value generation circuit, when there is a pulse with a pulse width greater than a preset width in the pulse signal.

In an embodiment, the controller is further configured to adjust the digital signal to decrease the threshold signals output by the dynamic threshold value generation circuit, when there is a pulse with a pulse width less than the preset width exists in the pulse signal or no pulse is detected.

In an embodiment, the controller is further configured to adjust the digital signal to decrease the threshold signals output by the dynamic threshold value generation circuit, when only one pulse or no pulse is detected in one detection period, after the digital signal is adjusted to increase the threshold signal output by the dynamic threshold value generation circuit. Optionally, the controller is further configured to switch to a high threshold if the pulse width exceeds the upper limit of a single pulse, after adjusting the digital signal to decrease the threshold signal output by the dynamic threshold value generation circuit.

The laser detection device includes a laser emitter, a laser detector, and a laser echo signal processing circuitry. When performing laser detection, the laser emitter first emits a laser to the target object, and the laser detector then receives the echo signal reflected by the target object. Subsequently, the laser echo signal processing circuitry samples the echo signal. The laser echo signal processing circuitry includes a controller, a time digital converter, and a dynamic threshold value generation circuit. The controller outputs a digital signal to the dynamic threshold value generation circuit, which generates at least two analog threshold signals to the time digital converter based on the digital signal. The time digital converter samples the echo signal based on the threshold signal. During the processing, multiple threshold signals are used to sample the echo signal, improving the sampling accuracy and thus enhancing the detection performance of the laser detection device.

### BRIEF DESCRIPTION OF DRAWINGS

One or more embodiments are exemplarily illustrated through the corresponding drawings. Elements with the same reference numerals in the drawings represent similar elements unless otherwise specified.

FIG. 1 is a schematic structural diagram of a laser detection device, according to some embodiments;

FIG. 2 is a schematic diagram of various signals in a laser detection device, according to some embodiments;

FIG. 3 is a schematic diagram of various signals in a laser detection device, according to some embodiments;

FIG. 4 is a structural schematic diagram of a laser echo signal processing circuitry, according to some embodiments;

FIG. 5 is a structural schematic diagram of a laser echo signal processing circuitry, according to some embodiments;

FIG. 6 is a schematic diagram of a circuit structure corresponding to the structure shown in FIG. 5, according to some embodiments;

FIG. 7 is a schematic diagram of another circuit structure corresponding to the structure shown in FIG. 5, according to some embodiments;

FIG. 8 is a structural schematic diagram of a laser echo signal processing circuitry, according to some embodiments;

FIG. 9 is a schematic diagram of a circuit structure corresponding to the structure shown in FIG. 8, according to some embodiments.

### DETAILED DESCRIPTION

To make the objectives, technical solutions, and advantages of this application clearer, the following will provide a clear description of the technical solutions in the embodiments of this application with reference to the drawings. Obviously, the described embodiments are part of the embodiments of this application.

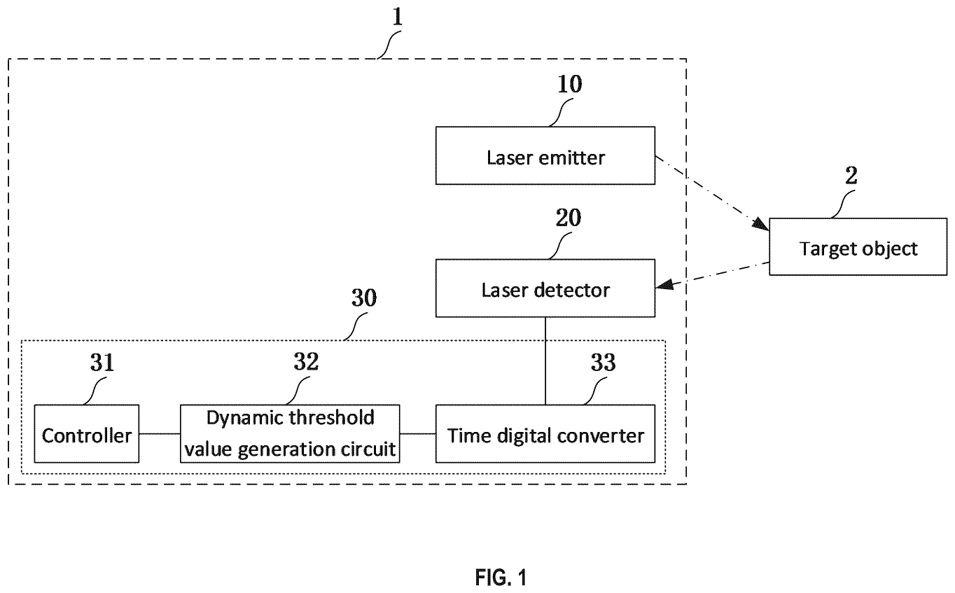

FIG. 1 is a schematic structural diagram of a laser detection device, according to some embodiments. As shown in FIG. 1, the laser detection device 1 includes a laser emitter 10, a laser detector 20, and a laser echo signal processing circuitry 30.

In some embodiments, the laser detection device 1 can be a laser radar, a signal processing device within a laser radar, or any device with distance measurement and speed measurement functions, such as a distance and speed measurement sensor or a distance and speed meter.

In an embodiment, the laser emitter 10 is used to emit a laser to a target object 2. The laser emitter 10 can emit pulsed detection lasers. The laser emitter 10 can be a semiconductor light-emitting diode (LED), a semiconductor laser diode (LD), or a vertical-cavity surface-emitting laser (VCSEL), among others. The type of laser emitter 10 can be set.

The laser detector 20 is used to receive an echo signal reflected by the target object 2. The laser emitted by the laser emitter 10 reflects off the target object 2, producing an echo signal. The laser detector 20 receives the echo signal and obtains information about the target object 2. For example, the flight time can be obtained by an emission time of the laser and a reception time of the echo signal, thereby determining a distance from the target object 2 to the laser detection device 1. In some embodiments, the laser detector 20 includes a photoelectric detector capable of detecting and converting an optical signal into an electrical signal.

The laser echo signal processing circuitry 30 is used to sample the echo signal. In an embodiment, the laser echo signal processing circuitry 30 and the laser detector 20 are two separate modules; in some embodiments, the laser echo signal processing circuitry 30 can be set within the laser detector 20.

The laser echo signal processing circuitry 30 includes a controller 31, a time digital converter 33, and a dynamic threshold value generation circuit 32. The controller 31 is electrically connected to the time digital converter 32 through the dynamic threshold value generation circuit 32.

In an embodiment, the controller 31 is used to output a digital signal to the dynamic threshold value generation circuit 32. The dynamic threshold value generation circuit 32 is used to generate at least two analog threshold signals to the time digital converter 33 based on the digital signal. The time digital converter 33 is used to perform sampling on the echo signal based on the threshold signals. Through the above process, multiple threshold signals can be used to sample the echo signal, which helps to distinguish echo signals with different amplitudes, thereby improving the accuracy of sampling and enhancing the detection performance of the laser detection device. Moreover, the threshold signals generated by the dynamic threshold value generation circuit 32 can change along with the digital signal. Thus, in different application scenarios, the controller 31 can output corresponding digital signal to obtain required threshold signals, so as to meet the needs of different application scenarios and have high practicality.

In some embodiments, the controller 31 can be a general-purpose processor, a digital signal processor (DSP), an application-specific integrated circuit (ASIC), a field-programmable gate array (FPGA), a microcontroller, an ARM processor, or any other programmable logic devices, discrete gate or transistor logic, discrete hardware components, or any combination of these parts. Furthermore, the controller 31 can also be any conventional processor, controller, microcontroller, or state machine. The controller 31 can also be implemented as a combination of computing devices, such as a combination of a DSP and a microprocessor, multiple microprocessors, one or more microprocessors combined with a DSP, or any other such configuration.

In some embodiments, the time digital converter 32 is configured to output a pulse signal based on a sampling result. The pulse signal includes at least one pulse, and each pulse is outputted when the echo signal is greater than or equal to the threshold signal.

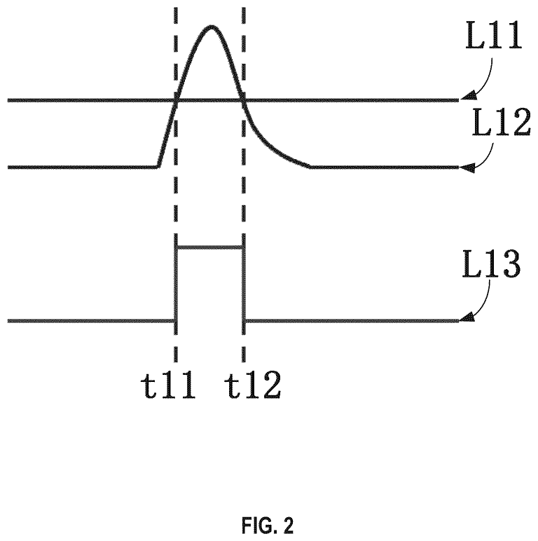

FIG. 2 is a schematic diagram of various signals in a laser detection device, according to some embodiments.

In an embodiment, referring to FIG. 2, the threshold signal, echo signal, and pulse signal are shown. As shown in FIG. 2, curve L11 is one of the threshold signals generated by the dynamic threshold value generation circuit 32 (here referred to as the first threshold signal); curve L12 is the echo signal; curve L13 is the pulse signal.

During the time period between t11 and t12, the echo signal remains or equals the first threshold signal, and the time digital converter 32 outputs a pulse. Subsequently, the time digital converter 32 can determine the distance from the target object 2 to the laser detection device 1 and a strength of the echo signal based on the pulse, such as determining the strength of the echo signal based on the pulse width.

Due to hardware defects of the laser detection device, usually only one threshold signal is used to sample the echo signal. Setting a single threshold signal makes it difficult to sample different echo signals accurately, resulting in poor sampling accuracy and affecting the detection performance of the laser detection device.

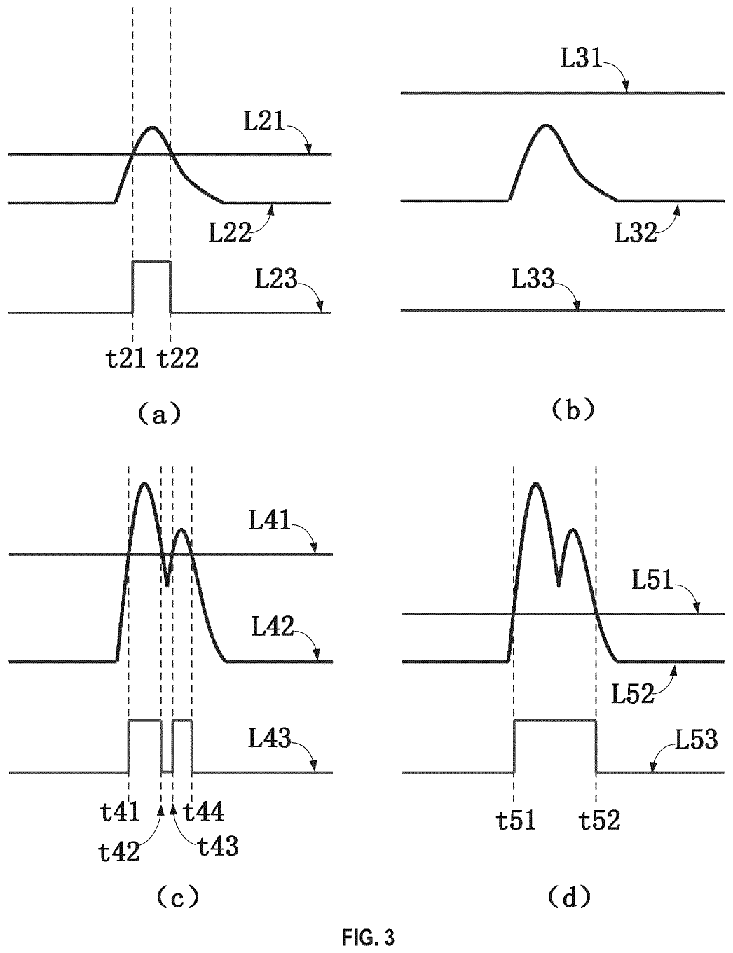

FIG. 3 is a schematic diagram of various signals in a laser detection device, according to some embodiments.

In an embodiment, a first situation is shown in part (a) of FIG. 3, where curve L21 is the threshold signal; curve L22 is the echo signal; curve L23 is the pulse signal. The echo signal has a single peak, and part of the echo signal is greater than the threshold signal, and part of the echo signal is less than the threshold signal. At this time, the pulse signal is generated, that is, during the time period between t21 and t22, the echo signal remains or equals the threshold signal, and the time digital converter 32 outputs a pulse.

In an embodiment, a second situation is shown in part (b) of FIG. 3, where curve L31 is the threshold signal; curve L32 is the echo signal; curve L33 is the signal output by the time digital converter 33 (not referred to as a pulse signal because there is no pulse). In this case, the threshold signal remains greater than the echo signal, and the time digital converter 33 does not output a pulse, making it impossible to sample the echo signal, thereby failing to detect the target object 2 and leading to poor detection performance of the laser detection device. In this case, it can be determined that the threshold signal is set too high.

In an embodiment, a third situation is shown in part (c) of FIG. 3, where curve L41 is the threshold signal; curve L42 is the echo signal; curve L43 is the pulse signal. The echo signal has two peaks (referred to as a continuous wave). Part of the echo signal is greater than the threshold signal, and part of it is less than the threshold signal. At this time, a pulse signal is generated based on the part of the echo signal greater than the threshold. During the time period between t41 and t42, the strength of the echo signal is greater than or equal to the threshold signal, and the time digital converter 32 outputs the first pulse; during the time period between t43 and t44, the strength of the echo signal is greater than or equal to the threshold signal, and the time digital converter 32 outputs the second pulse. For continuous wave signals, with a reasonable configuration of the threshold signal, two pulses can be obtained.

In an embodiment, a fourth situation is shown in part (d) of FIG. 3, where curve L51 is the threshold signal; curve L52 is the echo signal; curve L53 is the pulse signal. In this case, although the echo signal is a continuous wave, during the time period between t51 and t52, the strength of the echo signal is greater than or equal to the threshold signal, and the time digital converter 32 outputs only one pulse. There is an error in the sampling of the echo signal, and consequently, the detection of the target object 2 is also erroneous, leading to poor detection performance of the laser detection device. Therefore, in this case, inappropriate threshold settings can lead to inaccurate detection information.

In an embodiment, by adopting multiple threshold signals to adapt to different echo signals, accurate sampling of different echo signals can be completed, helping to prevent the issues mentioned above and improving the detection performance of the laser detection device 1.

In an embodiment, by adjusting the digital signal, the threshold signal can be adjusted dynamically to adapt to different echo signals. The controller is also configured to adjust the digital signal based on the pulse signal, to adjust the threshold signal output by the dynamic threshold value generation circuit.

In an embodiment, the controller may adjust the digital signal based on the pulse signal, to adjust the threshold signal output by the dynamic threshold. Specifically, the controller is also configured to adjust the digital signal to increase the threshold signal output by the dynamic threshold value generation circuit, if it is determined that there is a pulse with a pulse width greater than a preset width in the pulse signal.

The preset width is a pre-set width, which can be set based on application scenarios. In some embodiments, when it is determined that the echo signal is a single peak signal, the maximum width of the pulse that may occur for the echo signal can be obtained, and this maximum width is used as the preset width in the above embodiment.

Then, if there is a pulse with a pulse width greater than the preset pulse width in the pulse signal, it is determined that the echo signal may be a continuous wave. At this time, the digital signal can be adjusted to increase the threshold signal output by the dynamic threshold value generation circuit, to further determine whether the echo signal is a continuous wave.

For example, in FIG. 3, when there is a pulse with a pulse width greater than the preset pulse width in the pulse signal, the signal may be as shown in part (d) of FIG. 3. At this time, the digital signal can be adjusted to increase the threshold signal. If the echo signal is a continuous wave, two pulses can be obtained by increasing the threshold signal, as shown in part (c) of FIG. 3.

In an embodiment, if no continuous wave is detected after adjusting the digital signal to increase the threshold signal, it can be determined that the echo signal is a single peak signal, and the digital signal should be adjusted to decrease the threshold signal. In an embodiment, the controller is configured to adjust the digital signal to decrease the threshold signal output by the dynamic threshold value generation circuit, if only one pulse is detected in one detection period after the digital signal is adjusted to increase the threshold signal. In an embodiment, the controller is also configured to switch to a high threshold, if the pulse width exceeds a single pulse upper limit after adjusting the digital signal to decrease the threshold signal.

If only one pulse is detected in one detection period, it can be determined that the echo signal is not a continuous wave but a single peak signal. By adjusting the digital signal to decrease the threshold signal, it can prevent the anomaly of not detecting a pulse signal as shown in part (b) of FIG. 3 due to the threshold signal being set too high, or the anomaly of the pulse width being less than the preset pulse width, thereby improving the detection performance of the laser detection device 1.

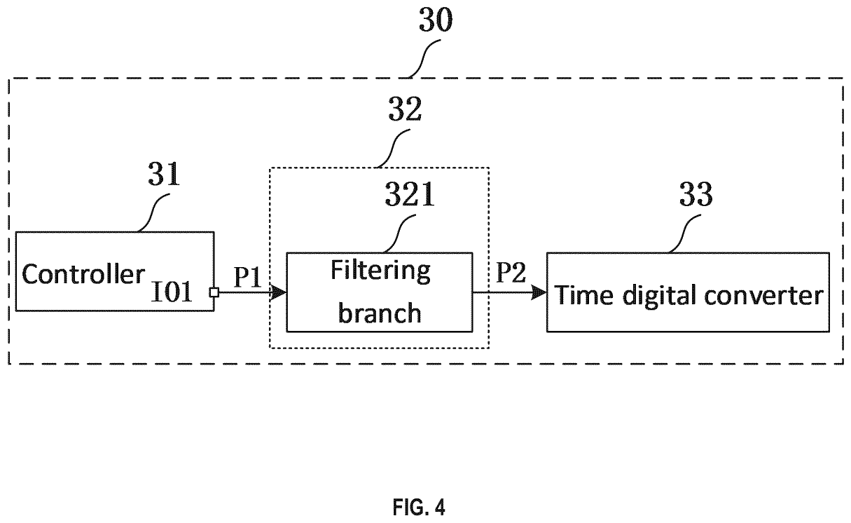

FIG. 4 is a structural schematic diagram of a laser echo signal processing circuitry, according to some embodiments.

In an embodiment, referring to FIG. 4, the controller 31 includes a first digital signal input/output port IO1, and the digital signal output by the first digital signal input/output port IO1 includes a pulse width modulation signal P1. The pulse width modulation (PWM) is a modulation technique used to control electronic devices by changing the pulse width to transmit information or control output.

In an embodiment, the dynamic threshold value generation circuit 32 includes a filtering branch 321. The filtering branch 321 is electrically connected between the first digital signal input/output port IO1 and the time digital converter 33. The filtering branch 321 is used to receive the pulse width modulation signal P1, and filter the received pulse width modulation signal P1, to generate the threshold signal P2. In an embodiment, the filtered signal of the pulse width modulation signal P1 is the threshold signal P2. The pulse width modulation signal P1 with different duty cycles correspond to different threshold signals P2. Thus, in this embodiment, by adjusting the duty cycle of the pulse width modulation signal P1, the threshold signal P2 can be adjusted to provide different threshold signals P2 for the time digital converter 33.

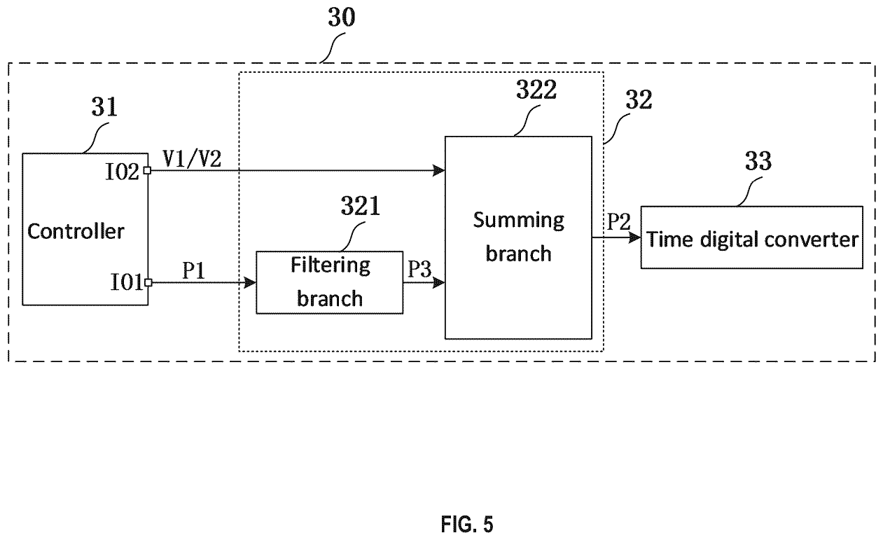

FIG. 5 is a structural schematic diagram of a laser echo signal processing circuitry, according to some embodiments.

In an embodiment, as shown in FIG. 5, the controller 31 includes a second digital signal input/output port IO2. The digital signal output by the second digital signal input/output port IO2 includes a first high-level signal V1 or a low-level signal V2. The dynamic threshold value generation circuit 32 includes a summing branch 322. The summing branch 322 is electrically connected to the filtering branch 321, the second digital signal input/output port IO2, and the time digital converter 33.

The summing branch 322 is used to sum a voltage signal obtained based on the first high-level signal V1 or the low-level signal V2 and a voltage signal P3 obtained by filtering the pulse width modulation signal P1, to generate the threshold signal P2. When the duty cycle of the pulse width modulation signal P1 remains unchanged, the threshold signals P2 corresponding to the first high-level signal V1 and the low-level signal V2 are different. In an embodiment, when the controller 31 outputs a first high-level signal V1, the summing branch 322 outputs a threshold signal P2 based on the summation result of the first high-level signal V1 and a voltage signal P3 obtained by filtering the pulse width modulation signal P1; when the controller 31 outputs a low-level signal V2, the summing branch 322 outputs another threshold signal P2 based on the summation result of the low-level signal V2 and a voltage signal P3 obtained by filtering the pulse width modulation signal P1. Thus, by outputting two different level signals through the second digital signal input/output port IO2 of the controller 31, the summing branch 322 can provide two threshold signals P2 for the time digital converter 33, enabling the time digital converter 33 to sample different echo signals, thereby improving the detection performance of the laser detection device. Additionally, the signal output by the second digital signal input/output port IO2 of the controller 31 can switch quickly, enabling fast switching of different threshold signals P2 to improve the efficiency and accuracy of sampling different echo signals. Furthermore, by adding digital signal input/output ports (similar to the second digital signal input/output port IO2) that output level signals in the same way, the summing branch 322 can provide more threshold signals P2 for the time digital converter 33, meeting the needs of different application scenarios with high practicality.

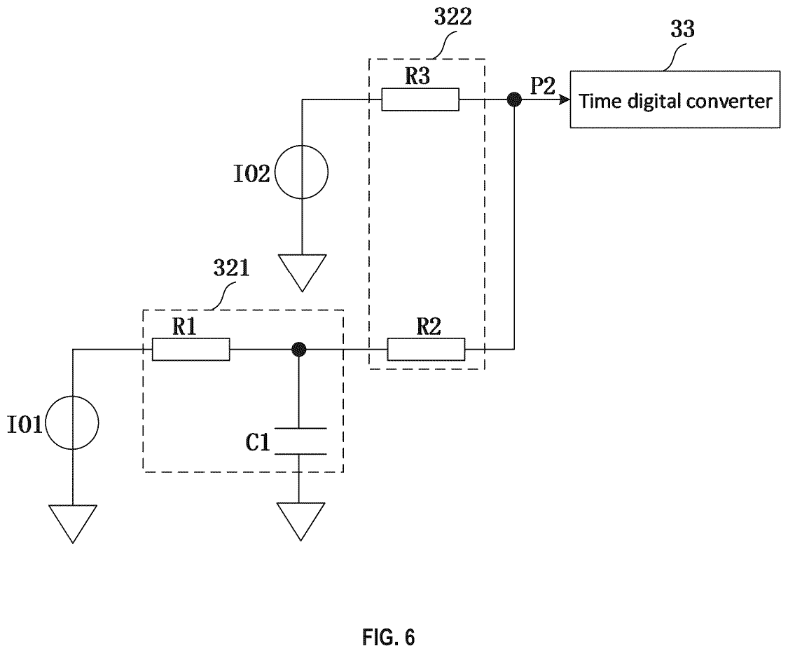

FIG. 6 is a schematic diagram of a circuit structure corresponding to the structure shown in FIG. 5, according to some embodiments.

In an embodiment, referring to FIG. 6, a circuit structure corresponding to the structure shown in FIG. 5 is shown.

In one embodiment, as shown in FIG. 6, the filtering branch 321 includes a first resistor R1 and a first capacitor C1.

The first resistor R1 and the first capacitor C1 are connected in series between the first digital signal input/output port IO1 and the ground, and the common node between the first resistor R1 and the first capacitor C1 is electrically connected to the time digital converter 33 through the summing branch 322.

In an embodiment, the first resistor R1 and the first capacitor C1 form an RC filter. The pulse width modulation signal output by the first digital signal input/output port IO1 can provide a threshold voltage for the time digital converter 33, after being filtered by the first resistor R1 and the first capacitor C1. By changing the duty cycle of the pulse width modulation signal, different threshold voltages can be provided for the time digital converter 33.

In an embodiment, the summing branch 322 includes a second resistor R2 and a third resistor R3.

The second resistor R2 is electrically connected between the filtering branch 321 and the time digital converter 33, and the third resistor R3 is electrically connected between the second digital signal input/output port IO2 and the time digital converter 33.

In an embodiment, the combination of the second resistor R2 and the third resistor R3 can sum the signal output by the second digital signal input/output port IO2 (the first high-level signal V1 or the low-level signal V2) and the filtered signal of the pulse width modulation signal output by the first digital signal input/output port IO1 in a certain proportion (the specific proportion is determined by the resistance values of the second resistor R2 and the third resistor R3), and based on the summation result, output the threshold signal P2 to the time digital converter 33.

The embodiment shown in FIG. 6 provides three ways to change the threshold signal P2, to meet the needs of different application scenarios with high practicality. The first way is to change the threshold signal P2 by changing the duty cycle of the pulse width modulation signal P1; the second way is to change the threshold signal P2 by switching between the first high-level signal V1 and the low-level signal V2, while keeping the duty cycle of the pulse width modulation signal P1 unchanged; the third way is to change the threshold signal P2 by changing the duty cycle of the pulse width modulation signal P1 and switching between the first high-level signal V1 and the low-level signal V2. Moreover, the method of changing the threshold signal P2 by switching between the first high-level signal V1 and the low-level signal V2 offers rapidity, improving the efficiency and accuracy of target detection.

The hardware structure of the laser echo signal processing circuitry 30 shown in FIG. 6 is just an example. The laser echo signal processing circuitry 30 can have more or fewer components than shown in the figure, combine two or more components, or have different component configurations. The various components shown in the figure can be implemented in hardware, software, or a combination of hardware and software, including one or more signal processing and/or application-specific integrated circuits.

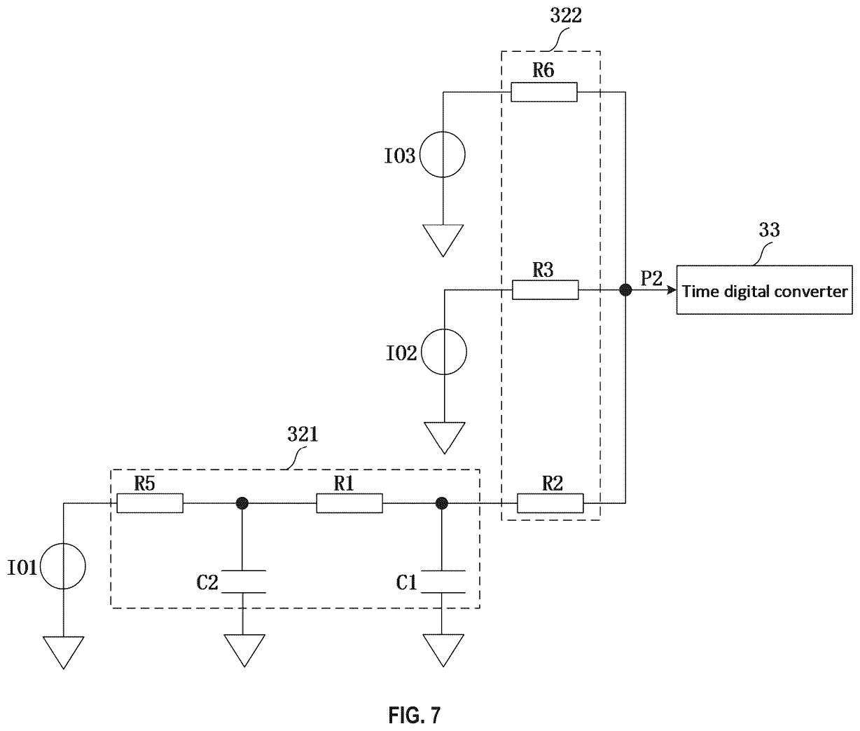

FIG. 7 is a schematic diagram of another circuit structure corresponding to the structure shown in FIG. 5, according to some embodiments.

In an embodiment, as shown in FIG. 7, the filtering branch 321 can be provided with an additional set of RC filter combinations. In an embodiment, the filtering branch 321 includes a second capacitor C2 and a fifth resistor R5.

The fifth resistor R5 and the second capacitor C2 are connected in series between the first digital signal input/output port IO1 and the ground, and the common node between the fifth resistor R5 and the second capacitor C2 is electrically connected to the time digital converter 33 through the first resistor R1 and the summing branch 322.

In an embodiment, the fifth resistor R5 and the second capacitor C2 form an RC filter. The pulse width modulation signal output by the first digital signal input/output port IO1 can provide a threshold voltage for the time digital converter 33 after passing through two RC filters (the RC filter formed by the fifth resistor R5 and the second capacitor C2 and the RC filter formed by the first resistor R1 and the first capacitor C1). Similarly, by changing the duty cycle of the pulse width modulation signal, different threshold voltages can be provided for the time digital converter 33.

In an embodiment, the controller 31 includes a third digital signal input/output port IO3, which can output the first high-level signal V1 and the low-level signal V2. The summing branch 322 also includes a sixth resistor R6.

The sixth resistor R6 is connected between the third digital signal input/output port IO3 and the time digital converter 33.

In an embodiment, the combination of the second resistor R2, the third resistor R3, and the sixth resistor R6 can sum the signal output by the third digital signal input/output port IO3, the signal outputted by the second digital signal input/output port IO2, and the filtered signal of the pulse width modulation signal output by the first digital signal input/output port IO1 in a certain proportion (the specific proportion is determined by the resistance values of the second resistor R2 and the third resistor R3), and based on the summation result, output the threshold signal P2 to the time digital converter 33.

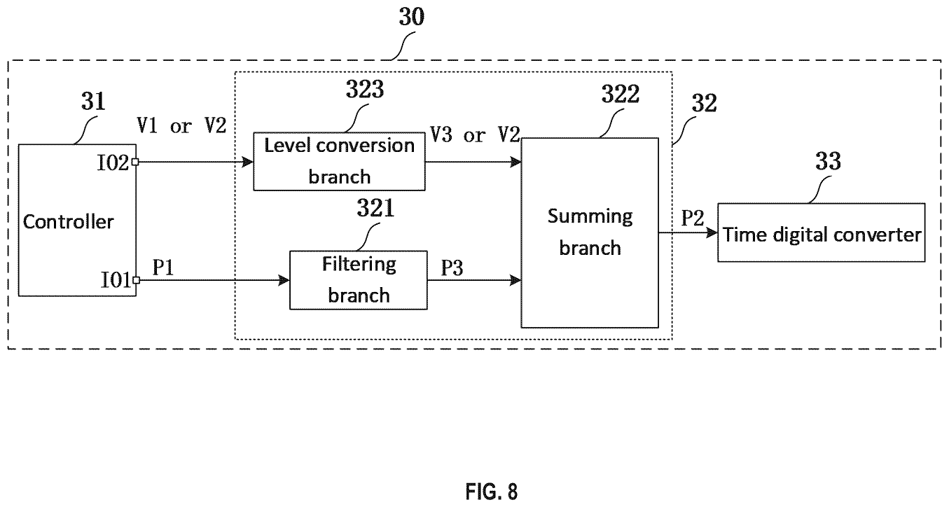

FIG. 8 is a structural schematic diagram of a laser echo signal processing circuitry, according to some embodiments

In an embodiment, as shown in FIG. 8, the dynamic threshold value generation circuit 32 includes a level conversion branch 323.

The level conversion branch 323 is connected between the second digital signal input/output port 102 and the summing branch 322. The level conversion branch 323 is used to output a second high-level signal V3 or a low-level signal V2 based on the digital signal output by the second digital signal input/output port IO2. The first high-level signal V1 and the second high-level signal V3 correspond to different voltages to achieve a level conversion process. For example, in some embodiments, the voltage corresponding to the first high-level signal V1 output by the second digital signal input/output port IO2 is 3.3V, and the voltage corresponding to the second high-level signal V3 output by the level conversion branch 323 is set to 5V, to meet the needs of different application scenarios.

The summing branch 322 is also used to sum the voltage signal obtained based on the second high-level signal V3 or the low-level signal V2 and the voltage signal obtained by filtering the pulse width modulation signal P1, to generate the threshold signal P2. When the duty cycle of the pulse width modulation signal P1 remains unchanged, the threshold signals corresponding to the second high-level signal V3 and the low-level signal V2 are different. In an embodiment, when the level conversion branch 323 outputs the second high-level signal V3, the summing branch 322 outputs a threshold signal P2 based on the summation result of the second high-level signal V3 and the voltage signal obtained by filtering the pulse width modulation signal P1; when the level conversion branch 323 outputs the low-level signal V2, the summing branch 322 outputs another threshold signal P2 based on the summation result of the low-level signal V2 and the voltage signal obtained by filtering the pulse width modulation signal P1. Thus, by outputting two different level signals through the level conversion branch 323, the summing branch 322 can provide two threshold signals P2 for the time digital converter 33, enabling the time digital converter 33 to sample different echo signals, thereby improving the detection performance of the laser detection device. the signal output by the second digital signal input/output port IO2 of the controller 31 and the signal output by the level conversion branch 323 can switch quickly, enabling fast switching of different threshold signals P2, improving the efficiency and accuracy of sampling different echo signals. Furthermore, by adding digital signal input/output ports of the controller 31 (similar to the second digital signal input/output port IO2) in the same way, corresponding level conversion branches 323 can be added to the summing branch 322 to provide more threshold signals P2 for the time digital converter 33, to meet the needs of different application scenarios with high practicality.

In an embodiment, a level conversion circuit or a driver circuit can be included between the controller IO1 and the filtering branch to adjust the voltage value P1 of the PWM signal output by the controller, achieving more flexible adjustment of the voltage range P3 output by the filter.

In an embodiment, in the circuit architecture shown in FIG. 8, an operational amplifier or an operational amplifier circuit can be added after any or all output ports of the controller input/output port IO1, the controller input/output port IO2, the output port of the filtering branch 321, and the output port of the summing branch, to further change the impedance matching characteristics, thereby improving the performance of threshold establishment.

In an embodiment, the filtering branch 321 can use an RC passive filter or an active filter built with an operational amplifier.

In an embodiment, the summing branch 322 can use direct resistance addition, or a summing circuit with an operational amplifier.

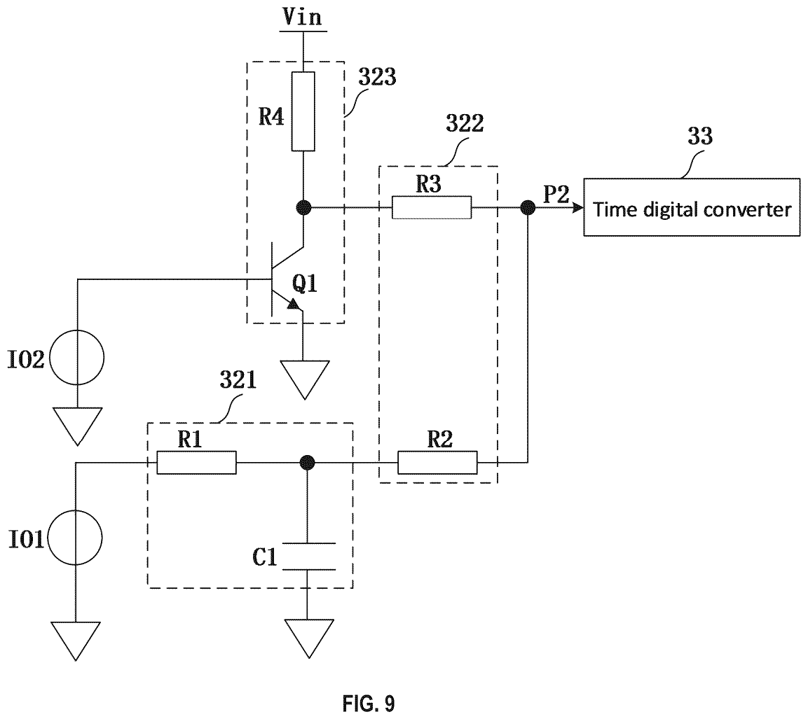

FIG. 9 is a schematic diagram of a circuit structure corresponding to the structure shown in FIG. 8, according to some embodiments.

In an embodiment, referring to FIG. 9, a circuit corresponding to the structure shown in FIG. 8 is shown. The circuit shown in FIG. 9 is based on the circuit shown in FIG. 6, with the level conversion branch 323 added.

In an embodiment, as shown in FIG. 9, the level conversion branch 323 includes a switch tube Q1 and a fourth resistor R4.

The control end of the switch tube Q1 is electrically connected to the second digital signal input/output port IO2. One non-control end of the switch tube Q1 is connected to the first end of the fourth resistor R4 and the summing branch 322, while the other non-control end of the switch tube Q1 is grounded. The second end of the fourth resistor R4 inputs a voltage Vin corresponding to the second high-level signal V2.

In an embodiment, when the first high-level signal V1 is output by the second digital signal input/output port IO2, the switch tube Q1 is turned on, forcing the common node between the switch tube Q1 and the fourth resistor R4 to be pulled low, thereby inputting the low-level signal to the summing branch 322.

When the low-level signal V2 is output by the second digital signal input/output port IO2, the switch tube Q1 is turned off, and the voltage Vin is input to the summing branch 322 through the fourth resistor R4, thereby inputting the second high-level signal V3 to the summing branch 322.

The level conversion process is achieved, which is applicable to application scenarios with different level requirements, demonstrating strong practicality.

The above embodiments or technical features in different embodiments can also be combined, and the steps can be implemented in any order. There are many other variations of the different aspects of this application as described above. For simplicity, they are not provided in detail.

What is claimed is:

1. A laser detection device, comprising:
a laser emitter, configured to emit a laser to a target object;
a laser detector, configured to receive an echo signal reflected by the target object; and
a laser echo signal processing circuitry, configured to sample the echo signal,
wherein the laser echo signal processing circuitry comprises a controller, a time digital converter and a dynamic threshold value generation circuit, and the controller is electrically connected to the time digital converter through the dynamic threshold value generation circuit;
wherein the controller is configured to output a digital signal to the dynamic threshold value generation circuit;
wherein the dynamic threshold value generation circuit is configured to generate at least two analog threshold signals to the time digital converter based on the digital signal; and
wherein the time digital converter is configured to sample the echo signal based on the threshold signals.

2. The laser detection device according to claim 1, wherein the controller comprises a first digital signal input/output port, and a digital signal output by the first digital signal input/output port comprises a pulse width modulation signal;
wherein the dynamic threshold value generation circuit comprises a filtering branch, the filtering branch is electrically connected to the first digital signal input/output port and the time digital converter, and the filtering branch is configured to receive the pulse width modulation signal and filter the pulse width modulation signal to generate the threshold signals; and
wherein the pulse width modulation signals with different duty cycles correspond to different threshold signals.

3. The laser detection device according to claim 2, wherein the controller further comprises a second digital signal input/output port, and a digital signal output by the second digital signal input/output port further comprises a first high-level signal or a low-level signal;
wherein the dynamic threshold value generation circuit further comprises a summing branch, the summing branch is electrically connected to the filtering branch, the second digital signal input/output port and the time digital converter, and the summing branch is configured to sum a voltage signal obtained based on the first high-level signal or the low-level signal and a voltage signal obtained by filtering the pulse width modulation signal, to generate the threshold signals; and
wherein when the duty cycle of the pulse width modulation signal remains unchanged, the threshold signals corresponding to the first high-level signal and the low-level signal are different.

4. The laser detection device according to claim 3, wherein the dynamic threshold value generation circuit further comprises a level conversion branch;
wherein the level conversion branch is connected to the second digital signal input/output port and the summing branch, and the level conversion branch is configured to output a second high-level signal or the low-level signal based on the digital signal output by the second digital signal input/output port, wherein voltages corresponding to the first high-level signal and the second high-level signal are different; and
wherein the summing branch is further configured to sum a voltage signal obtained based on the second high-level signal or the low-level signal and a voltage signal obtained by filtering the pulse width modulation signal, to generate the threshold signals, and when the duty cycle of the pulse width modulation signal remains unchanged, the threshold signals corresponding to the second high-level signal and the low-level signal are different.

5. The laser detection device according to claim 2, wherein the filtering branch comprises a first resistor and a first capacitor;
wherein the first resistor and the first capacitor are connected in series between the first digital signal input/output port and a ground, and a common node between the first resistor and the first capacitor is electrically connected to the time digital converter.

6. The laser detection device according to claim 3, wherein the summing branch comprises a second resistor and a third resistor;
wherein the second resistor is electrically connected to the filtering branch and the time digital converter, and the third resistor is electrically connected to the second digital signal input/output port and the time digital converter.

7. The laser detection device according to claim 4, wherein the level conversion branch comprises a switch tube and a fourth resistor;
wherein a control end of the switch tube is electrically connected to the second digital signal input/output port, one non-control end of the switch tube is connected to a first end of the fourth resistor and the summing branch, the other non-control end of the switch tube is grounded, and a second end of the fourth resistor inputs a voltage corresponding to the second high-level signal; and
wherein, when the second digital signal input/output port outputs the first high-level signal, the switch tube is turned on and outputs the low-level signal; and when the second digital signal input/output port outputs the low-level signal, the switch tube is turned off and outputs the second high-level signal.

8. The laser detection device according to claim 1, wherein the time digital converter is further configured to output a pulse signal based on a sampling result, and
wherein the pulse signal comprises at least one pulse, and each pulse is output when the echo signal is greater than or equal to the threshold signals; and
wherein the controller is further configured to adjust the digital signal based on the pulse signal, to adjust the threshold signals output by the dynamic threshold value generation circuit.

9. The laser detection device according to claim 8, wherein the controller is further configured to adjust the digital signal to increase the threshold signals output by the dynamic threshold value generation circuit, when there is a pulse with a pulse width greater than a preset pulse width in the pulse signal.

10. The laser detection device according to claim 9, wherein the controller is further configured to adjust the digital signal to decrease the threshold signals output by the dynamic threshold value generation circuit, when only one pulse is detected in one detection period after the digital signal is adjusted to increase the threshold signals output by the dynamic threshold value generation circuit.
